(19) United States
(12) Patent Application Publication
(10) Pub. No.: US 2025/0266706 A1
(43) Pub. Date: Aug. 21, 2025

(54) CONTROL APPARATUS

(71) Applicant: TOYOTA JIDOSHA KABUSHIKI KAISHA, Toyota-shi (JP)

(72) Inventors: Kentaro ASAI, Okazaki-shi (JP); Yu ETO, Nagoya-shi (JP)

(73) Assignee: TOYOTA JIDOSHA KABUSHIKI KAISHA, Toyota-shi (JP)

(21) Appl. No.: 19/058,459

(22) Filed: Feb. 20, 2025

(30) Foreign Application Priority Data
Feb. 21, 2024 (JP) 2024-024918

(51) Int. Cl. H02J 7/34; B60L 1/00; B60R 16/033; G07C 5/08; H01M 10/46; H02J 7/00

(52) U.S. Cl. CPC H02J 7/342; B60R 16/033; G07C 5/0808; H01M 10/46; H02J 7/0049; H02J 7/007; B60L 1/00

(57) ABSTRACT

A control apparatus controls charging of an emergency battery mounted as a power source for an emergency call apparatus mounted in a vehicle. The control apparatus includes a controller configured to determine, upon detecting that an ignition switch of the vehicle has been turned off, whether one or more charging conditions on the charging of the emergency battery are satisfied based on vehicle data indicating a state of the vehicle, and perform, upon determining that the one or more charging conditions are satisfied, control to start supplying power to the emergency battery from an auxiliary battery mounted in the vehicle.

### CROSS-REFERENCE TO RELATED APPLICATION

This application claims priority to Japanese Patent Application No. 2024-024918 filed on Feb. 21, 2024, the entire contents of which are incorporated herein by reference.

### TECHNICAL FIELD

The present disclosure relates to a control apparatus.

### BACKGROUND

In vehicles such as electric automobiles, it is common to install an emergency battery in addition to the main battery for driving the vehicle and an auxiliary battery that supplies power to functional equipment in the vehicle, such as an ECU that controls various vehicle functions, or a car navigation device. The term “ECU” is an abbreviation of Electronic Control Unit. The emergency battery is a backup battery (BUB) that supplies necessary power to an emergency call apparatus. The emergency battery is built into the emergency call apparatus. The emergency call apparatus is, for example, an in-vehicle communication device, such as a DCM. The term “DCM” is an abbreviation of Data Communication Module. The emergency call apparatus performs emergency operations such as the application of a vehicle emergency call system called eCall.

Generally, auxiliary batteries need to be charged once every two weeks for about 30 minutes, for example. When the power stored in the auxiliary battery is insufficient, a so-called “battery drain”, in which the power unit of the vehicle does not start, occurs. The auxiliary battery is charged while the ignition (IG) switch of the vehicle is on, i.e., while the main battery is in operation. The power required to charge the auxiliary battery is supplied by the main battery. It is also common for emergency batteries to be charged while the ignition switch is on. The power required to charge the emergency battery is supplied by the auxiliary battery.

The emergency battery is charged while the ignition switch of the vehicle is on for the following reasons. While the ignition switch of the vehicle is turned on, that is, while the vehicle is traveling and the main battery is operating, power is supplied from the main battery to the auxiliary battery, so unless there is a malfunction in the power supply path, a “battery drain” due to insufficient power stored in the auxiliary battery during traveling almost never occurs. However, power is not supplied from the main battery to the auxiliary battery while the ignition switch of the vehicle is off. Therefore, if the emergency battery is charged from the auxiliary battery while the ignition switch is off, the power stored in the auxiliary battery may be insufficient, resulting in the power unit not starting (a “battery drain” occurring).

Patent document (PTL) 1 discloses a technology for transmitting to an in-vehicle device and updating data received from outside the vehicle to the target in-vehicle device using power from an auxiliary power source when the power switch of the vehicle is turned off.

### CITATION LIST

### Patent Literature

PTL 1: JP 2023-045278 A

### SUMMARY

If power is supplied from the auxiliary battery to the emergency battery while the ignition switch of the vehicle is off, power shortages are likely to occur in the auxiliary battery.

It would be helpful to reduce the occurrence of power shortages in an auxiliary battery even when power is supplied from the auxiliary battery to an emergency battery while the ignition switch of a vehicle is off.

A control apparatus according to the present disclosure controls charging of an emergency battery mounted as a power source for an emergency call apparatus mounted in a vehicle. The control apparatus includes a controller configured to:
determine, upon detecting that an ignition switch of the vehicle has been turned off, whether one or more charging conditions on the charging of the emergency battery are satisfied based on vehicle data indicating a state of the vehicle; and
perform, upon determining that the one or more charging conditions are satisfied, control to start supplying power to the emergency battery from an auxiliary battery mounted in the vehicle.

According to the present disclosure, the occurrence of power shortages in an auxiliary battery is reduced even when power is supplied from the auxiliary battery to an emergency battery while the ignition switch of a vehicle is off.

### BRIEF DESCRIPTION OF THE DRAWINGS

In the accompanying drawings:

FIG. 1 is a block diagram illustrating a configuration of a control system according to an embodiment of the present disclosure; and

FIG. 2 is a flowchart illustrating operations of a control apparatus according to the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

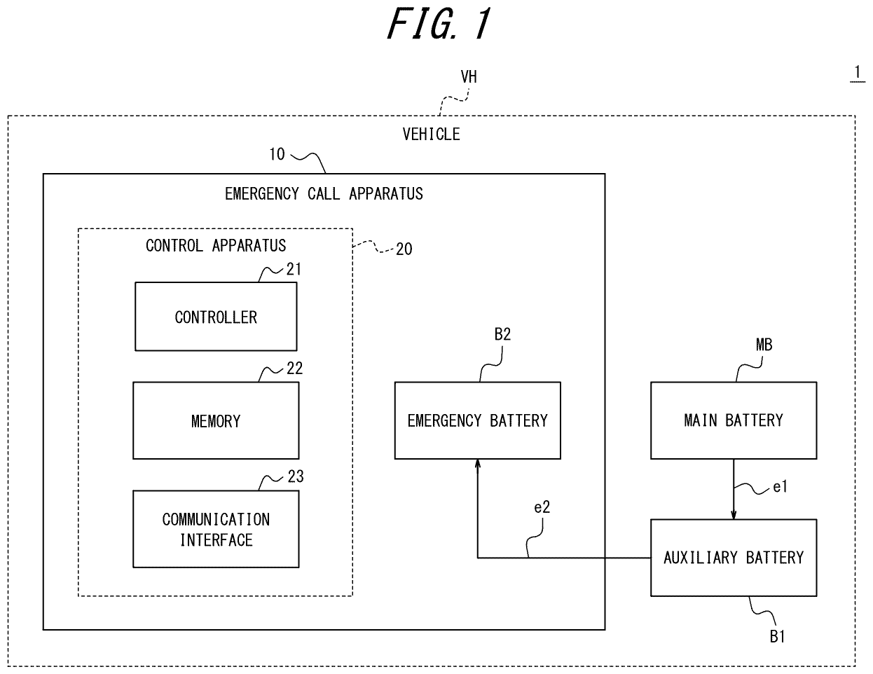

A configuration of a control system 1 according to the present embodiment will be described with reference to FIG. 1.

The control system 1 is equipped with a vehicle VH, an emergency call apparatus 10, a main battery MB, and an auxiliary battery B1. A control apparatus 20 and an emergency battery B2 are built into the emergency call apparatus 10. The emergency call apparatus 10, the main battery MB, and the auxiliary battery B1 are communicably connected to one another via an in-vehicle network, such as CAN, or dedicated lines, for example.

The emergency call apparatus 10 is, for example, an in-vehicle communication device, such as a DCM. The emergency call apparatus 10 is equipped with a vehicle emergency call system called eCall and is used to report the occurrence of an emergency event, such as an accident or collision of a vehicle VH, to an emergency call center. In the present embodiment, an antenna for communication with the outside of the vehicle VH is built into the emergency call apparatus 10. With this vehicle emergency notification system, the vehicle VH will automatically transmit an emergency call from the vehicle VH, even in the event of a serious automobile accident in which the driver and/or passengers lose consciousness.

The vehicle VH is, for example, any type of electric automobile such as an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. Vehicles VH include privately owned and commercial vehicles. The vehicle VH is a private car in the present embodiment, but is not limited to this, and may be any appropriate vehicle. The vehicle VH may be an AV whose operation is automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers.

The main battery MB is the drive battery for driving the vehicle VH. When the ignition switch is turned on in the vehicle VH, the main battery MB supplies the power necessary to drive the power unit, for example, the motor.

The auxiliary battery B1 is a battery that supplies power to functional equipment in the vehicle VH, such as an ECU that controls various vehicle functions, or a car navigation device. The auxiliary battery B1 is automatically charged when the ignition switch of the vehicle VH is on. The power required to charge the auxiliary battery B1 is supplied by the main battery MB. In FIG. 1, the flow of power from the main battery MB to the auxiliary battery B1 is indicated by arrow e1.

The emergency battery B2 is a backup battery that supplies necessary power to the emergency call apparatus 10. The power required to charge the emergency battery B2 is supplied from the auxiliary battery B1. In FIG. 1, the flow of power from the auxiliary battery B1 to the emergency battery B2 is indicated by arrow e2

The main battery MB, the auxiliary battery B1, and the emergency battery B2 can each comprise a rechargeable battery that can be repeatedly charged and discharged, such as a lithium-ion rechargeable battery or nickel metal hydride secondary battery. Instead of a secondary battery, other energy storage apparatuses such as a multilayer capacitor may be used. In the present embodiment, the emergency battery B2 is a nickel metal hydride secondary battery. The reason for using a nickel metal hydride secondary battery as the emergency battery B2 is discussed below. As noted above, the emergency battery B2 is built into the emergency call apparatus 10. The main battery 34 may be a large battery mounted, for example, in the rear of the vehicle VH. The auxiliary battery B1, for example, may be located anywhere in the vehicle VH, such as under the rear seat or in the trunk of the vehicle VH.

The control apparatus 20 controls the control system 1 according to the present embodiment. The control apparatus 20 includes a microcomputer with a processor, memory, and input/output interfaces. The said microcomputer is also called an ECU. At any given control timing, the control apparatus 20 collects measurement values of the remaining amount and the ambient temperature t1 of the emergency battery B2 and the open voltage of the auxiliary battery B1. The control apparatus 20 controls the main battery MB, the auxiliary battery B1, and the emergency battery B2. For example, the control apparatus 20 can start or stop supplying power from the main battery MB to the auxiliary battery B1. Similarly, the control apparatus 20 can start or stop supplying power from the auxiliary battery B1 to the emergency battery B2.

In FIG. 1, the control apparatus 20 is built into the emergency call apparatus 10, but the control apparatus 20 may be located outside the vehicle VH and connected to the vehicle VH and communicably by a network such as the Internet.

An outline of the present embodiment will be described with reference to FIG. 1.

The emergency call apparatus 10 has conventionally been installed in locations that are difficult to see, such as under the vehicle's instrument panel or at the feet of the occupants. The antenna for the emergency call apparatus 10 to communicate, for example, as a shark fin antenna or micro-antenna, was mounted outside the emergency call apparatus 10, for example, on the roof top of the vehicle. However, the recent incorporation of an antenna in the emergency call apparatus 10 for the purpose of cost reduction has made it necessary to change the mounting position of the emergency call apparatus 10, for example, to the top of the instrument panel or dashboard or near the roof, in order to improve the sensitivity of the antenna. However, if the emergency call apparatus 10 is mounted on the instrument panel or above the dashboard or near the roof, etc., the expected operating temperature at the mounting position of the emergency call apparatus 10 is expected to be higher than in the past. Therefore, instead of the conventional lithium-ion rechargeable battery, a nickel metal hydride secondary battery that can withstand high temperatures was used as the emergency battery B2 that supplies necessary power to the emergency call apparatus 10. The leakage current from the nickel metal hydride secondary battery at high temperatures was found to increase compared to that of the lithium-ion rechargeable battery. The temperature at the mounting position of the emergency call apparatus 10 also tends to be higher than the upper limit of the allowable temperature range for charging the nickel metal hydride secondary battery. As a result, even if the emergency battery B2 is charged while the ignition is switched on as in the past, if the vehicle equipped with the emergency call apparatus 10 is only driven during the daytime when the temperature is high, the temperature at the location where the emergency call apparatus 10 is installed may exceed the upper limit of the allowable temperature range for charging the emergency battery B2. The emergency battery B2 may not be charged even though the ignition switch is on. Insufficient charging of the emergency battery B2 is undesirable because the remaining amount (SOC) of the emergency battery B2 will decrease and the capacity required for emergency operation in the emergency call apparatus 10 will be insufficient, which may result in the inability to make said emergency call when an emergency call is required. The term “SOC” is an abbreviation of state of charge. Therefore, it was found necessary to charge the emergency battery B2 not only while the ignition switch of the vehicle VH is on, as in the past, but also while the ignition switch is off. However, since power is not supplied from the main battery MB to the auxiliary battery B1 while the ignition switch is switched off, there is a concern that if the emergency battery B2 is charged while the ignition switch is switched off, the remaining amount of the auxiliary battery B1 that supplies power to the emergency battery B2 will now be insufficient.

In the control system 1 according to the present embodiment, the control apparatus 20 controls charging of the emergency battery B2 mounted as a power source for the emergency call apparatus 10 mounted in the vehicle VH. Specifically, a controller 21 controls the power supply from the auxiliary battery B1 to the emergency battery B2 while the ignition switch of the vehicle VH is off. The control apparatus 20 determines, upon detecting that an ignition switch of the vehicle VH has been turned off, whether one or more charging conditions C on the charging of the emergency battery B2 are satisfied based on vehicle data D1 indicating the state of the vehicle VH, and performs, upon determining that the charging conditions C are satisfied, control to start supplying power to the emergency battery B2 from the auxiliary battery B1 mounted in the vehicle VH.

According to the present embodiment, in charging the emergency battery B2 while the ignition switch of the vehicle VH is off, a determination is made as to whether the charging conditions C are satisfied. According to this configuration, even if the emergency battery B2 is charged by supplying power from the auxiliary battery B1 to the emergency battery B2 while the ignition switch is turned off, inconveniences such as power being supplied from the auxiliary battery B1 to the emergency battery B2 even though there is not enough remaining amount in the auxiliary battery B1 can be avoided. Therefore, even if the emergency battery B2 is charged from the auxiliary battery B1 while the ignition switch of the vehicle VH is off, a power shortage in the auxiliary battery B1 is unlikely to occur.

A configuration of the control apparatus 20 according to the present embodiment will be described with reference to FIG. 1.

The control apparatus 20 includes the controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or a combination of at least two of these. The semiconductor memories are, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20. The vehicle data D1 indicating the state of the vehicle VH may be stored in the memory 22. The vehicle data D1 includes data indicating the remaining amount of the emergency battery B2, the open voltage of the auxiliary battery B1, and the ambient temperature t1 of the emergency battery B2 as the state of vehicle VH.

The communication interface 23 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 23 receives data to be used for the operations of the vehicle VH, and transmits data obtained by the operations of the vehicle VH. In the present embodiment, the communication interface 23 communicates with the emergency call center in the event of a vehicle VH emergency.

The functions of the control apparatus 20 are realized by execution of a program according to the present embodiment by a processor serving as the controller 21. That is, the functions of the control apparatus 20 are realized by software. The program causes a computer to execute the operations of the control apparatus 20, thereby causing the computer to function as the control apparatus 20. That is, the computer executes the operations of the control apparatus 20 in accordance with the program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

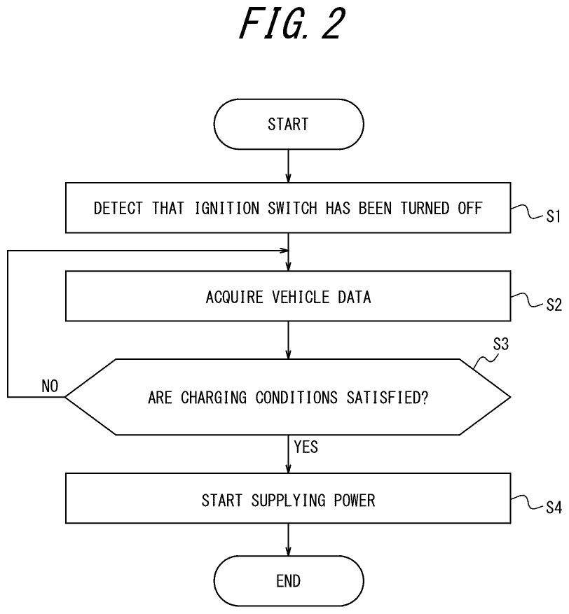

Operations of the control apparatus 20 according to the present embodiment will be described with reference to FIG. 2. These operations correspond to a control method according to the present embodiment. In other words, the control method according to the present embodiment includes steps S1 to S4 illustrated in FIG. 2. Each step in the flowchart is identified below by S and a number.

In S1, the controller 21 of the control apparatus 20 detects that the ignition switch of the vehicle VH has been turned off. Specifically, the controller 21 detects that the ignition switch has been turned off when the operating mode of the emergency call apparatus 10 is in Standby mode or Eco mode. “Standby mode” is a state in which the ignition switch is off and the emergency call apparatus 10 is in standby. “Eco mode” is a state in which the ignition switch is off and the emergency call apparatus 10 is activated by a command or other trigger or at a predetermined timing. When the ignition switch is in the off state, the power source supply from the main battery MB to the auxiliary battery B1 is stopped.

In S2, the controller 21 of the control apparatus 20 acquires vehicle data D1. The vehicle data D1 includes data indicating the remaining amount of the emergency battery B2, the open voltage of the auxiliary battery B1, and the ambient temperature t1 of the emergency battery B2 as the state of vehicle VH. The vehicle data D1 can be acquired by any procedure. The controller 21 collects a measurement value of an open voltage from the auxiliary battery B1. The controller 21 collects measurement values of SOC and the ambient temperature t1 from the emergency battery B2. The controller 21 acquires each collected measurement value as vehicle data D1. The controller 21 may store the acquired vehicle data D1 in the memory 22.

In S3, the controller 21 of the control apparatus 20 determines whether the charging conditions C on the charging of the emergency battery B2 are satisfied based on the vehicle data D1 acquired in S1. In the present embodiment, the charging conditions C include the first condition C1 that the remaining amount of the emergency battery B2 is less than the first threshold Th1, the second condition C2 that the open voltage of the auxiliary battery B1 is equal to or greater than the second threshold Th2, and the third condition C3 that the ambient temperature t1 is within the predetermined range.

Here, the concept of setting the charging conditions C is explained.

As the first condition C1, the first threshold Th1 is set as the minimum capacity required as power for the emergency call apparatus 10 to operate in an emergency. The first threshold Th1 can be, for example, 60% of the total capacity of the emergency battery B2. As the second condition C2, the minimum voltage required as the open voltage to start the auxiliary battery B1 is set as the second threshold Th2. The second threshold Th2 is, for example, 12.5 V. The third condition C3 is a temperature range within which the emergency battery B2 can be charged as a predetermined range. For example, if the nominal charge temperature range of the nickel metal hydride secondary battery employed as the emergency battery B2 is 0° C. to 50° C., the range of ambient temperature t1 in the third condition C3 is set to 0° C. to 50° C. These specific values listed as charging conditions C are examples and can be set freely as long as the emergency battery B2 has the capacity required for emergency operation, the emergency battery B2 can be charged from the auxiliary battery B1, and the open voltage in the auxiliary battery B1 is not insufficient to supply power from the auxiliary battery B1 to the emergency battery B2.

In S3, the controller 21 of the control apparatus 20 determines that the charging conditions C are satisfied when all of the first condition C1, the second condition C2, and the third condition C3 are satisfied. If any one of the first condition C1, the second condition C2, and the third condition C3 is not satisfied, the controller 21 determines that charging conditions C are not satisfied. When it is determined that the charging conditions C are satisfied in S3, the process of S4 is performed.

On the other hand, if it is determined in S3 that the charging conditions C are not satisfied, the process returns to S2 and the process is performed again. The process of S2 and S3 can be repeated at any timing as long as the ignition switch of the vehicle VH is not turned on, but it is desirable that the process be repeated at least once every 24 hours. For example, suppose that in S3, it is determined that charging conditions C are not satisfied because the third condition C3 is not satisfied among the first condition C1, the second condition C2, and the third condition C3. In this case, since the ambient temperature t1 can vary over time after the ignition switch has been turned off, the S2 process may be performed again several hours later. Alternatively, the controller 21 may, for example, predict temperature changes over a day based on data from temperature sensors or weather forecast data in the vehicle VH, determine the point at which the ambient temperature t1 becomes a temperature that meets the third condition C3, and determine when to perform the S2 process again.

In S4 of FIG. 2, the controller 21 of the control apparatus 20 performs control to start charging the emergency battery B2. Specifically, the controller 21 performs control to start supplying power to the emergency battery B2 from the auxiliary battery B1.

As described above, the control apparatus 20 according to the present embodiment controls charging of the emergency battery B2, which is mounted as a power source for the emergency call apparatus 10 mounted in the vehicle VH. The control apparatus 20 determines, upon detecting that an ignition switch of the vehicle VH has been turned off, whether one or more charging conditions C on the charging of the emergency battery B2 are satisfied based on vehicle data D1 indicating the state of the vehicle VH, and performs, upon determining that the charging conditions C are satisfied, control to start supplying power to the emergency battery B2 from the auxiliary battery B1 mounted in the vehicle VH.

According to the present embodiment, in charging the emergency battery B2 while the ignition switch of the vehicle VH is off, a determination is made as to whether the charging conditions C are satisfied. According to this configuration, even if power is supplied from the auxiliary battery B1 to the emergency battery B2 while the ignition switch of the vehicle VH is off, for example, the inconvenience of supplying power from the auxiliary battery B1 to the emergency battery B2 even though the remaining amount of the auxiliary battery B1 is not sufficient can be avoided. Therefore, even if power is supplied from the auxiliary battery B1 to the emergency battery B2 while the ignition switch of the vehicle VH is off, a power shortage in the auxiliary battery B1 is unlikely to occur.

In the embodiment described above, the state of the vehicle VH, i.e., the remaining amount of the emergency battery B2, the open voltage of the auxiliary battery B1, and the ambient temperature t1 of the emergency battery B2, may vary over time. Therefore, the controller 21 of the control apparatus 20 may monitor whether the charging conditions C are satisfied while the ignition switch is turned off after starting supplying power to the emergency battery B2 from the auxiliary battery B1 in S4. Specifically, the controller 21 may determine whether charging conditions C are satisfied each time a predetermined time elapses while the ignition switch is turned off. The predetermined time can be freely determined, but it is desirable, for example, that this be done at least once every 12 hours. If the controller 21 determines that the charging conditions C are not satisfied in S4, it may perform control to stop supplying power to the emergency battery B2 from the auxiliary battery B1. Specifically, the process of S2 and S3 may be repeated after starting supplying power to the emergency battery B2 from the auxiliary battery B1 in S4 of FIG. 2. In this case, when it is determined in S3 that the charging conditions C are satisfied, the controller 21 of the control apparatus 20 performs control to continue supplying power to the emergency battery B2 from the auxiliary battery B1. On the other hand, when it is determined in S3 that the charging conditions C are not satisfied, the controller 21 performs control to stop supplying power to the emergency battery B2 from the auxiliary battery B1. In the present embodiment, the process of S2 and S3 may be repeated until the emergency battery B2 is fully charged, unless the ignition switch of the vehicle VH is turned on. Any procedure may be used to determine whether the emergency battery B2 is fully charged. In the present embodiment, the following procedure, for example, may be used.

After starting supplying power from the auxiliary battery B1 to the emergency battery B2 in S4 of FIG. 2, the controller 21 of the control apparatus 20 acquires the remaining time until full charge based on the SOC of the emergency battery B2, and monitors whether the emergency battery B2 is fully charged by counting the acquired remaining time. The remaining time may be acquired freely. For example, the controller 21 calculates the remaining time based on the SOC to the full charge (rated capacity) of the emergency battery B2, assuming that the amount of current from the auxiliary battery B1 to the emergency battery B2 is constant when the emergency battery B2 starts charging. Alternatively, the remaining time for charging may be stored in advance in the memory 22 of the control apparatus 20, which is pre-mapped to each SOC value of the emergency battery B2. In such a case, the controller 21 acquires, for example, the numerical value of SOC at the time when the supply of power to emergency battery B2 is started, and acquires from the memory 22 the remaining time for charging corresponding to that numerical value. The controller 21 may further acquire information indicating the health (SOH) of the emergency battery B2. SOH″ is an abbreviation for State Of Health. For example, if SOH is defined by the current capacity/rated capacity of the emergency battery B2, the value obtained by multiplying the rated capacity by the value of SOH may be considered the fully charged capacity of the emergency battery B2, and the remaining time may be calculated from the remaining charge to that capacity.

According to the present embodiment, the controller 21 of the control apparatus 20 monitors whether the charging conditions C are satisfied while the ignition switch is off after the ignition switch of the vehicle VH is turned off and charging of the emergency battery B2 is started, and if the charging conditions C are no longer satisfied, the emergency battery B2 charging is stopped. According to such a configuration, during charging of the emergency battery B2 after the supply of electric power from the auxiliary battery B1 to the emergency battery B2 is started while the ignition switch is off, if the state of the vehicle VH, i.e., the remaining amount of the emergency battery B2, the open voltage of the auxiliary battery B1, and/or the ambient temperature t1 of the emergency battery B2, changes over time, and if any of the first condition C1, the second condition C2, and the third condition C3 is no longer satisfied, the charging conditions C are determined to no longer be satisfied and the charging of the emergency battery B2 is stopped. After the ignition switch of the vehicle VH is turned off and charging of the emergency battery B2 is started, a case in which charging conditions C are no longer satisfied while the ignition switch is off can be assumed, for example, when charging of the emergency battery B2 is started in the early morning and the temperature rises during the day. According to the present embodiment, in such a case, the supply of electric power from the auxiliary battery B1 to the emergency battery B2 is stopped because the third condition C3 regarding the ambient temperature t1 of the emergency battery B2 among the charging conditions C is no longer satisfied. Therefore, inconveniences such as supplying power to the emergency battery B2 even though it has exceeded the temperature range at which the emergency battery B2 can be charged can be avoided. Another case in which charging conditions C are no longer satisfied after the ignition switch is turned off and charging of the emergency battery B2 is started is, for example, when the open voltage of the auxiliary battery B1 drops due to the supply of power to the emergency battery B2. According to the present embodiment, in such a case, the supply of power from the auxiliary battery B1 to the emergency battery B2 is stopped because the second condition C2 of the charging conditions C is no longer satisfied. Thus, for example, the system avoids the inconvenience of continuing to supply power from the auxiliary battery B1 to the emergency battery B2 even though there is no margin of remaining amount in the auxiliary battery B1.

In the embodiment described above, it is assumed that the ignition switch of the vehicle VH is turned on while power is being supplied to the emergency battery B2. The process in this case is described below.

Upon detecting that the ignition switch of the vehicle VH has been turned on while supplying power to the emergency battery B2, the controller 21 of the control apparatus 20 monitors whether the conditions other than the second condition C2 among the charging conditions C are satisfied. Specifically, the controller 21 determines whether any of the charging conditions C other than the second condition C2 is satisfied each time a predetermined time elapses while the ignition switch is turned on. The predetermined time can be arbitrarily determined, but it is desirable, for example, that this be done at least once every 12 hours. The reason why the judgment is made for conditions other than the second condition C2 among the charging conditions C is that the ignition switch of the vehicle VH has been turned on, which starts supplying power from the main battery MB to the auxiliary battery B1 and charges the auxiliary battery B1, so the second condition C2, that the open voltage of the auxiliary battery B1 is equal to or greater than the second Therefore, the second condition C2 that the open circuit voltage of the auxiliary battery B1 is equal to or greater than the second threshold Th2 is no longer considered.

The controller 21 of the control apparatus 20 performs control to stop supplying power to the emergency battery B2 from the auxiliary battery B1 when conditions other than the second condition C2, i.e., the first condition C1 or the third condition C3, are no longer satisfied while the ignition switch of the vehicle VH is on.

According to such a configuration, if the ignition switch of the vehicle VH has been turned on while supplying power from the auxiliary battery B1 to the emergency battery B2 with the ignition switch of the vehicle VH turned off, a judgment is made on conditions other than the second condition C2 among the charging conditions C. In other words, while the ignition switch of the vehicle VH is on, the controller 21 of the control apparatus 20 does not have to make a judgment on the second condition C2 among the charging conditions C, thus reducing the processing load of the controller 21.

In the embodiment described above, when the controller 21 of the control apparatus 20 stops supplying power to the emergency battery B2 from the auxiliary battery B1 while the ignition switch of the vehicle VH is off or on, the count of the remaining time until the emergency battery B2 is fully charged is suspended without resetting. The count may then be restarted when the supply of power to the emergency battery B2 is resumed. According to such a configuration, the controller 21 of the control apparatus 20 does not need to acquire the remaining time until the emergency battery B2 is fully charged each time it resumes supplying power from the auxiliary battery B1 to the emergency battery B2. Thus, the processing load of the controller 21 can be reduced.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

1. A control apparatus for controlling charging of an emergency battery mounted as a power source for an emergency call apparatus mounted in a vehicle, the control apparatus comprising a controller configured to:
determine, upon detecting that an ignition switch of the vehicle has been turned off, whether one or more charging conditions on the charging of the emergency battery are satisfied based on vehicle data indicating a state of the vehicle; and
perform, upon determining that the one or more charging conditions are satisfied, control to start supplying power to the emergency battery from an auxiliary battery mounted in the vehicle.

2. The control apparatus according to claim 1, wherein
the vehicle data includes data indicating, as the state of the vehicle, a remaining amount of the emergency battery, an open voltage of the auxiliary battery, and an ambient temperature of the emergency battery,
the one or more charging conditions include a first condition that the remaining amount indicated by the vehicle data is less than a first threshold, a second condition that the open voltage is equal to or greater than a second threshold, and a third condition that the ambient temperature is within a predetermined range, and
the controller is configured to determine that the one or more charging conditions are satisfied in a case in which all of the first condition, the second condition, and the third condition are satisfied.

3. The control apparatus according to claim 1, wherein the controller is configured to:
monitor whether the one or more charging conditions are satisfied after starting supplying power to the emergency battery from the auxiliary battery; and
perform control to stop supplying power to the emergency battery from the auxiliary battery when the one or more charging conditions are no longer satisfied.

4. The control apparatus according to claim 2, wherein
the controller is configured to:
calculate a remaining time until full charge based on the remaining amount and a capacity of the emergency battery after starting supplying power to the emergency battery from the auxiliary battery;
monitor whether the emergency battery is fully charged by counting the calculated remaining time, and
the controller is configured to:
monitor, upon detecting that the ignition switch of the vehicle has been turned on while power is supplied to the emergency battery from the auxiliary battery, whether conditions other than the second condition among the one or more charging conditions are satisfied; and
perform control to stop supplying power to the emergency battery from the auxiliary battery without resetting a count of the remaining time when the conditions other than the second condition are no longer satisfied.

5. The control apparatus according to claim 1, wherein
the emergency call apparatus includes an antenna built into the emergency call apparatus, and
the emergency battery is a nickel metal hydride secondary battery.
